(19) United States
(12) Patent Application Publication
(10) Pub. No.: US 2016/0114552 A1
(43) Pub. Date: Apr. 28, 2016

(54) SHEER MEMBERS AND METHODS OF MAKING AND USING THE SAME

(71) Applicant: GM Global Technology Operations LLC, Detroit, MI (US)

(72) Inventors: Christopher G. Basela, Ortonville, MI (US); Edward D. Moss, Commerce Township, MI (US)

(21) Appl. No.: 14/525,896

(22) Filed: Oct. 28, 2014

(51) Int. Cl. B32B 3/26; B32B 5/12; B32B 37/18; B32B 38/00; B32B 37/12; B32B 5/02; B32B 15/14

(52) U.S. Cl. CPC B32B 3/266; B32B 5/024; B32B 5/12; B32B 15/14; B32B 38/0004; B32B 37/12; B32B 37/18; B32B 2260/021; B32B 2260/046; B32B 2262/106; B32B 2262/0269; B32B 2605/00; B32B 2262/101; B32B 2313/04; B32B 2377/00; B32B 2315/085; B32B 2037/1253

(57) ABSTRACT

One variation includes a sheer member and method of manufacture thereof wherein the sheer member may be fabricated from a core, a shell, and a bonding agent, wherein at least one of the shell or the core comprises a pultruded material comprising carbon and at least one of the shell or the core comprises a woven composite filament.

### TECHNICAL FIELD

The field to which the disclosure generally relates to includes sheer members including, but not limited to, materials used in vehicle frames and structures, such as, but not limited to frames or structures included in passenger vehicles, motor cycles, bicycles, rough terrain vehicles, watercraft, trains, aircraft, or spacecraft, as well as structural material used in the fields of sports & leisure, construction, civil engineering, machining, and other various technical fields.

### BACKGROUND

Currently, some sheer members may be formed from metal to provide bracing to frames and structures in some vehicles or other applications.

### SUMMARY OF ILLUSTRATIVE VARIATIONS

A number of variations may include a product comprising a shell, a core, and a bonding agent, wherein the shell at least partially overlays the core, wherein at least one of the shell or the core comprises a pultruded material comprising carbon and at least one of the shell or the core comprises a woven composite filament.

Another variation may include shows a method of manufacturing a sheer member comprising: providing a shell, a core, and a bonding agent, pultruding at least one of the shell or the core through a bonding agent wherein at least some of the bonding agent contacts the core or the shell, positioning the shell over at least a portion of the core, and curing the bonding agent to form the sheer member, wherein at least one of the shell or the core comprises carbon and at least one of the shell or the core comprises a woven composite filament.

Other illustrative variations within the scope of the invention will become apparent from the detailed description provided hereinafter. It should be understood that the detailed description and specific examples, while disclosing optional variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is a cross-sectional and perspective view of a product according to a number of variations.

FIG. 2 is a method according to a number of variations.

### DETAILED DESCRIPTION OF ILLUSTRATIVE VARIATIONS

The following description of the variations is merely illustrative in nature and is in no way intended to limit the scope of the invention, its application, or uses.

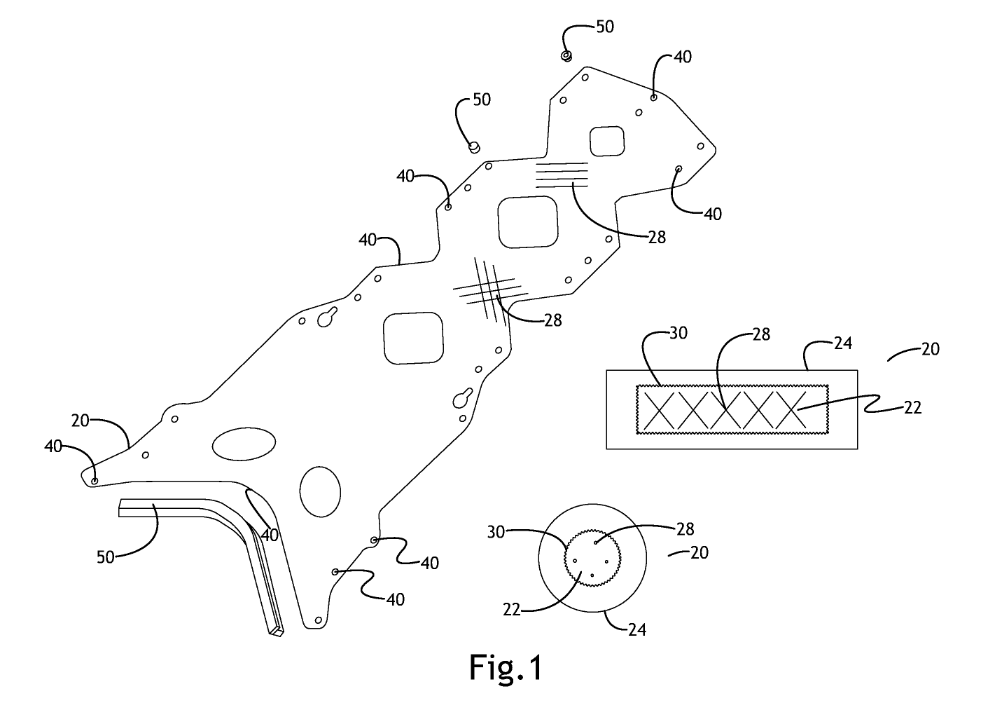

A product 20 is provided in FIG. 1. In a number of variations, the product 20 may be a sheer member (20). In a number of variations, such a sheer member 20 may be useful in applications such as frames, beams, springs, close-out members, chassis members, or other structures used in vehicles or may be used for other applications. In a number of variations, the sheer member 20 may provide high strength to mass ratio over other sheer materials such as metal. In a number of variations, the sheer member 20 may provide a weight reduction over other sheer materials such as metal. In a number of variations, the sheer member 20 may provide an ability to tailor or map the properties of member along its length, width, or thickness, for strength and/or mass when desired to fit the application of the sheer member. In a number of variations, the sheer member 20 may include a plurality of layers. In a number of variations, the sheer member 20 may include a core 22. In a number of variations, the core 22 may include a plurality of fibers. In a number of variations, the fibers may be textile, natural or synthetic or may be another type. In a number of variations, the fibers in the core 22 may include animal, vegetable, or mineral fibers including, but not limited to, alpaca, angora, byssus, camel hair, cashmere, catgut, chiengora, guanaco, llama, mohair, pashmina, qiviut, rabbit, silk, sinew, spider silk, wool, vicuna, yak, abaca′, bagasse, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, aramid (including Twaron, Kevlar, Technora, Nomex), microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, or carbon nanotube reinforced polymer, fiber reinforced polymer, fiberglass (including E-glass, A-glass, E-CR-glass, C-glass, D-glass, R-glass, and S-glass, or may be another type), basalt, aluminum, or may be another type. In a number of variations, the core 22 may contain combinations of the above in varying concentrations and the components may be intermixed. In a number of variations, additional woven composite filament 28 may also be formed from these components. In a number of variations, the woven composite filament 28 may be single directional or multi directional. In a number of variations, the woven composite filament 28 may provide increased sheer and impact/fatigue resistance. In a number of variations, the core 22 or the woven composite filament 28 may be formed by sheets, continuous mats, or as continuous filaments. In a number of variations, the woven composite filament 28 may be added only to certain portions of the core 22. In a number of variations, the core 22 may be formed using a hand lay-up operation, a spray lay-up operation, a pultrusion operation, a chopped strand mat, vacuum bag moulding, pressure bag moulding, autoclave moulding, resin transfer moulding, vacuum assisted resin transfer moulding, bladder moulding, compression moulding, mandrel wrapping, wet layup, chopper gun, filament winding, melting, staple fiber, continuous filament, or may be formed another way. In a number of variations, the core 22 can be manufactured in a two dimensional or three dimensional orientation. In a number of variations, the core 22 may include short-fiber reinforced materials or continuous fiber-reinforced materials or may include another type. In a number of variations, the core 22 may be manufactured or woven through weaving, knitting, braiding, stitching, plain weaving, satin weaving, or may be manufactured in another way. In a number of variations, the core 22 may have various widths, lengths and/or diameters of fibers as well as in its overall dimensions. In a number of variations, the core 22 may comprise either a filament and a weave or both in any combination and composition. In a number of variations, the filament and weave may be in the same or different directions. In a number of variations, the core 24 may include internal or external ribbing. In a number of variations, the core 22 may be preimpregnated, coated, or otherwise in contact with a bonding agent 30.

Still referring the FIG. 1, in a number of variations, the sheer member 20 may further include a shell 24. In a number of variations, the shell 24 may include a plurality of fibers. In a number of variations, the fibers may be textile, natural or synthetic or may be another type. In a number of variations, the fibers in the shell 24 may include animal, vegetable, or mineral fibers including, but not limited to, alpaca, angora, byssus, camel hair, cashmere, catgut, chiengora, guanaco, llama, mohair, pashmina, qiviut, rabbit, silk, sinew, spider silk, wool, vicuna, yak, abaca′, bagasse, bamboo, coir, cotton, flax, hemp, jute, kapok, kenaf, pina, raffia, ramie, sisal, wood, asbestos, acetate, triacetate, art silk, lyocell rayon, silica, modal rayon, rayon, glass, carbon, basalt, metallic, acrylic, aramid (including Twaron, Kevlar, Technora, Nomex), microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, or carbon nanotube reinforced polymer, fiber reinforced polymer, fiberglass (including E-glass, A-glass, E-CR-glass, C-glass, D-glass, R-glass, and S-glass, or may be another type), basalt, aluminum, or may be another type. In a number of variations, the shell 24 may contain combinations of the above in varying concentrations and the components may be intermixed. In a number of variations, additional woven composite filament 28 may also be formed from these components. In a number of variations, the woven composite filament 28 may be single directional or multi directional. In a number of variations, the woven composite filament 28 may provide increased sheer and impact/fatigue resistance. In a number of variations, the shell 24 or the woven composite filament 28 may be formed by sheets, continuous mats, or as continuous filaments. In a number of variations, the woven composite filament 28 may be added only to certain portions of the shell 24. In a number of variations, the shell 24 may be formed using a hand lay-up operation, a spray lay-up operation, a pultrusion operation, a chopped strand mat, vacuum bag moulding, pressure bag moulding, autoclave moulding, resin transfer moulding, vacuum assisted resin transfer moulding, bladder moulding, compression moulding, mandrel wrapping, wet layup, chopper gun, filament winding, melting, staple fiber, continuous filament, or may be formed another way. In a number of variations, the shell 24 can be manufactured in a two dimensional or three dimensional orientation. In a number of variations, the shell 24 may include short-fiber reinforced materials or continuous fiber-reinforced materials or may include another type. In a number of variations, the shell 24 may be manufactured or woven through weaving, knitting, braiding, stitching, plain weaving, satin weaving, or may be manufactured in another way. In a number of variations, the shell 24 may have various widths, lengths and/or diameters of fibers as well as in its overall dimensions. In a number of variations, the shell 24 may comprise either a filament and a weave or both in any combination and composition. In a number of variations, the filament and weave may be in the same or different directions. In a number of variations, the shell 24 may include internal or external ribbing. In a number of variations, the shell 24 may be preimpregnated, coated, or otherwise in contact with a bonding agent 30.

Referring to FIG. 1, in a number of variations, the sheer member 20 may be machined to form at least one hole 40 within the sheer member 20. In a number of variations, the hole 40 may be defined as an opening within or on the side of the sheer member 20. In a number of variations, the hole 40 may be circular, polygonal, half circular, u-shaped, or may be another type. In a number of variations, the hole 40 may be punched, machine routered, water jet machined, or may be formed another way. In a number of variations, at least one insert 50 may be positioned into contact with the hole 40. In a number of variations, the insert 50 may attach the sheer member 20 to other components, braces, or compartments in a vehicle, or may be used another way. In a number of variations, the insert 50 may act as a galvanic corrosion isolator to a body attachment point or a fastener to a body attachment point and allow for higher torque loading. In a number of variations, the insert 50 may be any shape including, but not limited to, a circle, a parabola, a half circle, an ellipse, a polygon, a triangle, or may be another shape. In a number of variations, the insert 50 may comprise prongs. The term prong may be defined as a projection of the insert 50 in the direction of a different plane from the rest of the insert 50. In a number of variations, the insert 50 may be comprised of a metal, polymer, textile, or may be another type. In a number of variations, the insert 50 may be metal in the form of an element, compound, or alloy. In a number of variations, the insert 50 metal may comprise titanium, steel, cast iron, alloy steel, stainless steel, platinum, palladium, aluminum, copper, nickel, iron, lead, tin, cobalt, bronze, or may be another type. In a number of variations, the insert 50 may comprise a textile comprising an animal textile, a plant textile, a mineral textile, or a synthetic textile. In a number of variations, the insert 50 may comprise a composite material including, but not limited to, a fiber-reinforced polymer, a thermoplastic composite, a metal matrix composite, a ceramic matrix composite, an organic matrix composite, a fiber-reinforced composite, a polyester, a vinyl ester, an epoxy, a phenolic polymer, a polyimide polymer, a polyamide polymer, a polypropylene, PEEK, or may be another type. In a number of variations, the insert 50 may be pre machined through a stamp and roll or may be machined another way. In a number of variations, the insert 50 may be a bearing including a plain bearing, rolling-element bearing, jewel bearing, fluid bearing, magnetic bearing, flexure bearing, or may be another type. In a number of variations, the insert 50 may be a plain bearing and may be an integral type, bushing type, two-piece type, or may be another type.

Still referring to FIG. 1, in a number of variations, a bonding agent 30 may be held in contact with the core 22, shell 24, and/or insert 50. In a number of variations, this contact may result in adherence or bonding between the bonding agent 30, the core 22, shell 24, or insert 50, or any combination thereof. In a number of variations, the bonding agent 30 may include urethane resin, vinylester resin, polyester resin, epoxy resin, phenolic resin, modified phenolic resin or may be another type. In a number of variations, the bonding agent 30 may be reactive or non-reactive.

In a number of variations, the insert 50 may comprise a different shape. In a number of variations, the insert 50 may comprise a split ring shape. The split shape may be any pattern. In a number of variations, the insert 50 may comprise a U-shape. The insert 50 may comprise prongs on both or one side of the U or may comprise prongs anywhere on the insert 50. In a number of variations, the insert 50 may comprise a cylinder. In a number of variations, the insert 50 may comprise a prong on a side or top of the cylinder or may comprise prongs anywhere on the insert 50. In a number of variations, in a number of variations, the insert 50 may contain serrations or knearling for attachment to either the sheer member 20 or to an attachment (not shown). In a number of variations, the insert 50 may contain an adhesive for attachment to either the sheer member 20 or to an attachment (not shown). An attachment may be defined as anything to which a sheer member 20 can attach to. In a number of variations, the attachment may comprise a part including, but not limited to, bolt, slot, edge, recess, fastener, buckle, button, cable tie, clamp, clip, clutch, flange, frog, grommet, latch, nail, peg, pin, hook and loop fastener, rivet, screw anchor, snap fastener, staple, stitch, strap, threaded fastener, tie, toggle bolt, zipper, wedge anchor, or may be another type. In a number of variations, the adhesive may be a metal epoxy, resin, silicone, polyurethane, polysifide, cyanoacrylate, UV-cure, or may be another type. In a number of variations, the insert 50 may be the attachment and may be attached to another component via any of the attachments above or a welding process (including arc welding, gas metal arc welding, shielded metal arc welding, bolting, or may be another type) or may be attached in a different way.

In a number of variations, the sheer member 20 may be produced by various fabrication or manufacturing methods. In a number of variations, the sheer member 20 may be in two or three dimensional orientation. In a number of variations, the core 22 or shell 24, or both or neither may be manufactured or woven through weaving, knitting, braiding, stitching, plain weaving, satin weaving, or may be manufactured another way. In a number of variations, at least one of a weave, a knit, a braid, a stitch, a plain weave, or a satin weave can be added to the core 22, to the shell 24, to both or to neither during manufacture or fabrication. Some examples of orientations of the at least one of a weave, a knit, a braid, a stitch, a plain weave, or a satin weave include, but are not limited to, 90 degree, 45 degree, or 60 degree or may be another degree. In a number of variations, fibers in the core 22 or the shell 24 or both or neither may be bundled prior to manufacture or may be bundled during manufacture. In a number of variations, the core 22 may be pultruded by a tension roller and contacted with a bonding agent 30. In a number of variations, the shell 24 may be pultruded by a tension roller and contacted with a bonding agent 30. In one variation both the core 22 and the shell 24 may be pultruded by a tension roller and contacted with a bonding agent. In a number of variations, the core 22, the shell 24, or both or neither may be held in contact and cured to form a sheer member 20. In a number of variations, the shell 24 may at least partially overlay the core 22. In a number of variations, the core 22 and the shell 24 may be held together in contact by a tension roller. In a number of variations, the core 22 and shell 24 may be formed from pultrusion. In a number of variations, the core 22 and the shell 24 may be pultruded through a molding head or at least one bobbin. In a number of variations, the core 22 or the shell 24 may be pultruded through a molding head or at least one bobbin. In a number of variations, additional woven composite filament 28 fibers may be added to either the core 22 or the shell 24 before and/or after curing. In a number of variations, a sweep can be added to the sheer member 20 to form a desired shape before the sheer member 20 may be completely cured. In a number of variations, the sweep can be any level of degree as necessary for a desired application. Some examples of sweep include, but are not limited to, 0 degree, 90 degree, 45 degree, or 60 degree or may be another degree. In a number of variations, a sweep may be added through a curved track. In a number of variations, the sheer member 20 may be cut to a desired length for a desired application. In a number of variations, the sheer member 20 may be machined, cut, pierced, or routered to form at least one hole 40 in the sheer member 20, or the hole 40 may be added another way. In a number of variations, at least one insert 50 may be positioned in contact with the hole 40. In a number of variations, the insert 50 may include serrations, knearling, or an adhesive for contact with the hole 40 or to an attachment. In a number of variations, other methods may be used to form the sheer member 20. These methods include, but are not limited to, hand lay-up operation, a spray lay-up operation, a chopped strand mat, vacuum bag moulding, pressure bag moulding, autoclave moulding, resin transfer moulding, injection moulding, vacuum assisted resin transfer moulding, bladder moulding, compression moulding, mandrel wrapping, face sheet rolling, wet layup, chopper gun, filament winding, or may be formed another way. In a number of variations, the sheer member 20 may be formed to sheets in an orientation of the core 22, shell 24, and bonding agent 30 in any combination or layer formation. In a number of variations, the sheer member 20 may be finished with other methods for a final design. In a number of variations, a mold may be tooled to form the desired shape or variation of the sheer member 20 for its intended application. A person of skill in the art would recognize these techniques. A pultruded material may be defined as any material that has undergone pultrusion.

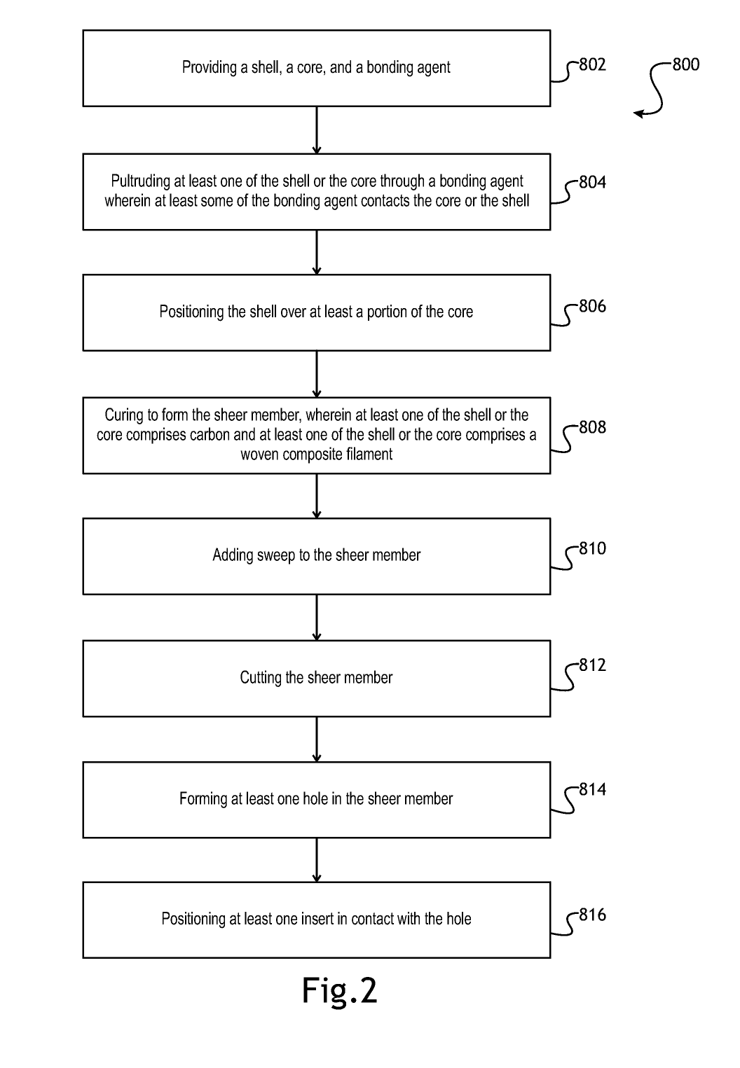

FIG. 2 shows a method 800 according to a number of variations. In a number of variations, the method 800 may include in block 802 providing a shell 24, a core 22, and a bonding agent 30. In a number of variations, the method 800 may further include, in block 804, pultruding at least one of the shell 24 or the core 22 through a bonding agent 30 wherein at least some of the bonding agent contacts the core 22 or the shell 24. In a number of variations, the method 800 may further include, in block 806, positioning the shell 24 over at least a portion of the core 22. In a number of variations, additional layers may lie between the shell 24 and/or the core 22 and may comprise similar material compositions as the shell 24 and/or the core 22. In a number of variations, the method 800 may further include, in block 808, curing to form the sheer member 20, wherein at least one of the shell 24 or the core 22 comprises carbon and at least one of the shell 24 or the core 22 comprises a woven composite filament 28. In a number of variations, the method 800 may further include, in block 810, adding sweep to the sheer member 20. In a number of variations, the method 800 may further include, in block 812, cutting the sheer member 20. In a number of variations, the method 800 may further include, in block 814, forming at least one hole 40 in the sheer member 20. In a number of variations, the method 800 may further include, in block 816, positioning at least one insert 50 in contact with the hole 40.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include a product including a shell, a core, and a bonding agent, wherein the shell at least partially overlays the core, wherein at least one of the shell or the core comprises a pultruded material comprising carbon and at least one of the shell or the core comprises a woven composite filament.

Variation 2 may include a product as set forth in Variation 1 wherein at least one hole is formed in the product.

Variation 3 may include a product as set forth in any of Variations 1-2 wherein at least one insert is positioned in contact with the hole.

Variation 4 may include a product as set forth in any of Variations 1-3 wherein the woven composite filament comprises carbon.

Variation 5 may include a product as set forth in any of Variations 1-4 wherein the woven composite filament comprises aramid.

Variation 6 may include a product as set forth in any of Variations 1-5 wherein the insert comprises a metal comprising at least one of stainless steel or titanium.

Variation 7 may include a product as set forth in any of Variations 1-6 wherein the core further comprises a pultruded material comprising a glass fiber.

Variation 8 may include a product as set forth in any of Variations 1-7 wherein the woven composite filament comprises a fiber oriented in a different direction from the core.

Variation 9 may include a product as set forth in any of Variations 1-8 wherein the bonding agent comprises a resin comprising at least one of vinylester resin, polyester resin, epoxy resin, phenolic resin, or modified phenolic resin.

Variation 10 may include a product as set forth in any of Variations 1-9 wherein the sheer member has a sweep.

Variation 11 may include a method of manufacturing a sheer member including: providing a shell, a core, and a bonding agent; pultruding at least one of the shell or the core through a bonding agent wherein at least some of the bonding agent contacts the core or the shell; positioning the shell over at least a portion of the core; and curing the bonding agent to form the sheer member, wherein at least one of the shell or the core comprises carbon and at least one of the shell or the core comprises a woven composite filament.

Variation 12 may include a method as set forth in Variation 12 further including: cutting the sheer member.

Variation 13 may include a method as set forth in and of Variations 11-12 further including: forming at least one hole in the sheer member, and positioning at least one insert in contact with the hole.

Variation 14 may include a method as set forth in any of Variations 11-13 wherein the woven composite filament comprises carbon.

Variation 15 may include a method as set forth in Variations 11-14 wherein the woven composite filament comprises aramid.

Variation 16 may include a method as set forth in any of Variations 11-15 wherein the insert comprises a metal comprising at least one of stainless steel or titanium.

Variation 17 may include a method as set forth in any of Variations 11-16 wherein the core further comprises a pultruded material comprising a glass fiber.

Variation 18 may include a method as set forth in any of Variations 11-17 wherein the woven composite filament comprises a fiber oriented in a different direction from the core.

Variation 19 may include a method as set forth in any of Variations 11-18 wherein the bonding agent comprises a resin comprising at least one of vinylester resin, polyester resin, epoxy resin, phenolic resin, or modified phenolic resin.

Variation 20 may include a method as set forth in any of Variations 11-19 wherein the sheer member has a sweep.

Variation 21 may include a product as set forth in any of Variations 1-11 wherein the woven composite filament composition is adjusted along the length, width, and/or thickness of the sheer member.

Variation 22 may include a product or method as set forth in any of Variations 1-21 wherein the core comprises at least one fiber including at least one of alpaca, angora, byssus, camel hair, cashmere, catgut, chiengora, guanaco, llama, mohair, pashmina, qiviut, rabbit, silk, sinew, spider silk, wool, vicuna, yak, abaca′, bagasse, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, aramid (including Twaron, Kevlar, Technora, Nomex), microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, or carbon nanotube reinforced polymer, fiber reinforced polymer, fiberglass, basalt, or aluminum or combinations thereof.

Variation 23 may include a product or method as set forth in any of Variations 1-22 wherein the core further comprises a woven composite filament including at least one fiber including at least one of alpaca, angora, byssus, camel hair, cashmere, catgut, chiengora, guanaco, llama, mohair, pashmina, qiviut, rabbit, silk, sinew, spider silk, wool, vicuna, yak, abaca′, bagasse, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, aramid (including Twaron, Kevlar, Technora, Nomex), microfiber, modacrylic, nylon, olefin, polyester, polyethylene, spandex, vinylon, vinyon, zylon, saran, carbon-f iber-reinforced polymer, carbon-fiber-reinforced plastic, carbon-fiber reinforced thermoplastic, or carbon nanotube reinforced polymer, fiber reinforced polymer, fiberglass, basalt, or aluminum.

Variation 24 may include a product or method as set forth in any of Variations 1-23 wherein the shell comprises at least one fiber including at least one of alpaca, angora, byssus, camel hair, cashmere, catgut, chiengora, guanaco, llama, mohair, pashmina, qiviut, rabbit, silk, sinew, spider silk, wool, vicuna, yak, abaca′, bagasse, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, aramid (including Twaron, Kevlar, Technora, Nomex), microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, or carbon nanotube reinforced polymer, fiber reinforced polymer, fiberglass, basalt, or aluminum or combinations thereof.

Variation 25 may include a product or method as set forth in any of Variations 1-24 wherein the shell further comprises a woven composite filament including at least one fiber including at least one of alpaca, angora, byssus, camel hair, cashmere, catgut, chiengora, guanaco, llama, mohair, pashmina, qiviut, rabbit, silk, sinew, spider silk, wool, vicuna, yak, abaca′, bagasse, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, aramid (including Twaron, Kevlar, Technora, Nomex), microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, or carbon nanotube reinforced polymer, fiber reinforced polymer, fiberglass, basalt, or aluminum.

Variation 26 may include a product or method as set forth in any of Variations 1-25 wherein the woven composite filament may be single directional or multi directional.

Variation 27 may include a product or method as set forth in any of Variations 1-26 wherein the shell and/or core is formed by sheets, continuous mats, or as continuous filaments.

Variation 28 may include a product or method as set forth in any of Variations 1-27 wherein the woven composite filament is added only to certain portions of the core and/or shell.

Variation 29 may include a product or method as set forth in any of Variations 1-28 wherein the shell and/or core may be manufactured in a two dimensional or three dimensional orientation.

Variation 30 may include a product or method as set forth in any of Variations 1-29 wherein at least one of the core or the shell is manufactured by at least one of weaving, knitting, braiding, stitching, plain weaving, or satin weaving.

Variation 31 may include a product or method as set forth in any of Variations 1-30 wherein the shell and/or core includes short-fiber reinforced materials or continuous fiber-reinforced materials.

Variation 32 may include a product or method as set forth in any of Variations 1-31 wherein the shell and/or core includes a filament and weave in different directions.

Variation 33 may include a product or method as set forth in any of Variations 1-32 wherein the shell and/or core includes internal or external ribbing.

Variation 34 may include a product or method as set forth in any of Variations 1-33 wherein the insert is formed in the shape of a circle, a parabola, a half circle, an ellipse, a polygon, or a triangle.

Variation 35 may include a product or method as set forth in any of Variations 1-34 wherein the insert includes at least one of titanium, steel, cast iron, alloy steel, stainless steel, platinum, palladium, aluminum, copper, nickel, iron, lead, tin, cobalt, or bronze.

Variation 36 may include a product or method as set forth in any of Variations 1-35 wherein the insert includes at least one of a fiber-reinforced polymer, a thermoplastic composite, a metal matrix composite, a ceramic matrix composite, an organic matrix composite, a fiber-reinforced composite, a polyester, a vinyl ester, an epoxy, a phenolic polymer, a polyimide polymer, a polyamide polymer, a polypropylene, or PEEK.

Variation 37 may include a product or method as set forth in any of Variations 1-36 wherein the insert includes a bearing including at least one of a plain bearing, rolling-element bearing, jewel bearing, fluid bearing, magnetic bearing, or a flexure bearing.

Variation 38 may include a product or method as set forth in any of Variations 1-37 wherein the insert includes a plain bearing including at least one of an integral type, bushing type, or a two-piece type.

Variation 39 may include a product or method as set forth in any of Variations 1-38 wherein the bonding agent is reactive.

Variation 40 may include a product or method as set forth in any of Variations 1-39 wherein the adhesive includes one of metal epoxy, resin, silicone, polyurethane, polysifide, cyanoacrylate, or a UV-cure.

Variation 41 may include a product or method as set forth in any of Variations 1-40 wherein at least one of the core and/or the shell includes at least one of a weave, a knit, a braid, a stitch, a plain weave, or a satin weave of any degree.

Variation 42 may include a product or method as set forth in any of Variations 1-41 wherein the hole is circular, polygonal, half circular, or u-shaped.

Variation 43 may include a product or method as set forth in any of Variations 1-42 wherein the sheer member is formed by at least one of a hand lay-up operation, a spray lay-up operation, a chopped strand mat, vacuum bag moulding, pressure bag moulding, autoclave moulding, resin transfer moulding, injection moulding, vacuum assisted resin transfer moulding, bladder moulding, compression moulding, mandrel wrapping, wet layup, chopper gun, or filament winding.

Variation 44 may include a product or method as set forth in any of Variations 1-43 wherein at least one of the core and/or the shell is pultruded by a tension roller through a molding head.

Variation 45 may include a product or method as set forth in any of Variations 1-44 wherein the hole is punched, machine routered, water jet machined into the sheer member.

Variation 46 may include a product or method as set forth in any of Variations 1-45 wherein insert is coupled to an attachment through at least one of a bolt, slot, edge, recess, fastener, buckle, button, cable tie, clamp, clip, clutch, flange, frog, grommet, latch, nail, peg, pin, hook and loop fastener, rivet, screw anchor, snap fastener, staple, stitch, strap, threaded fastener, tie, toggle bolt, zipper, wedge anchor, or through a welding process.

Variation 47 may include a product or method as set forth in any of Variations 1-46 wherein the sweep is 90 degree, 45 degree, or 60 degree.

Variation 48 may include a product or method as set forth in any of Variations 1-47 wherein fibers in the core or the shell or both are bundled prior to manufacture.

Variation 49 may include a product or method as set forth in any of Variations 1-48 wherein insert includes serrations or knearling.

The above description of select variations is merely illustrative in nature and, thus, variations or variants thereof are not to be regarded as a departure from the spirit and scope of the invention.

What is claimed is:

1. A product comprising: a shell, a core, and a bonding agent, wherein the shell at least partially overlays the core, wherein at least one of the shell or the core comprises a pultruded material comprising carbon and at least one of the shell or the core comprises a woven composite filament.

2. A product as set forth in claim 1 wherein at least one hole is formed in the product.

3. A product as set forth in claim 2 wherein at least one insert is positioned in contact with the hole.

4. A product as set forth in claim 1 wherein the woven composite filament comprises carbon.

5. A product as set forth in claim 1 wherein the woven composite filament comprises aramid.

6. A product as set forth in claim 3 wherein the insert comprises a metal comprising at least one of stainless steel or titanium.

7. A product as set forth in claim 1 wherein the core further comprises a pultruded material comprising a glass fiber.

8. A product as set forth in claim 1 wherein the woven composite filament comprises a fiber oriented in a different direction from the core.

9. A product as set forth in claim 1 wherein the bonding agent comprises a resin comprising at least one of vinylester resin, polyester resin, epoxy resin, phenolic resin, or modified phenolic resin.

10. A product as set forth in claim 1 wherein the sheer member has a sweep.

11. A method of manufacturing a sheer member comprising:
providing a shell, a core, and a bonding agent;
pultruding at least one of the shell or the core through a bonding agent wherein at least some of the bonding agent contacts the core or the shell;
positioning the shell over at least a portion of the core; and
curing the bonding agent to form the sheer member, wherein at least one of the shell or the core comprises carbon and at least one of the shell or the core comprises a woven composite filament.

12. A method as set forth in claim 11 further comprising: cutting the sheer member.

13. A method as set forth in claim 11 further comprising: forming at least one hole in the sheer member, and positioning at least one insert in contact with the hole.

14. A method as set forth in claim 11 wherein the woven composite filament comprises carbon.

15. A method as set forth in claim 11 wherein the woven composite filament comprises aramid.

16. A method as set forth in claim 13 wherein the insert comprises a metal comprising at least one of stainless steel or titanium.

17. A method as set forth in claim 11 wherein the core further comprises a pultruded material comprising a glass fiber.

18. A method as set forth in claim 11 wherein the woven composite filament comprises a fiber oriented in a different direction from the core.

19. A method as set forth in claim 11 wherein the bonding agent comprises a resin comprising at least one of vinylester resin, polyester resin, epoxy resin, phenolic resin, or modified phenolic resin.

20. A method as set forth in claim 11 wherein the sheer member has a sweep.
